(19) United States
(12) Patent Application Publication
(10) Pub. No.: US 2025/0211313 A1
(43) Pub. Date: Jun. 26, 2025

(54) SYSTEMS AND METHODS FOR PARALLEL DATA BUFFERING AND BEAM TRAINING WITH DUAL-POLARIZED ANTENNAS

(71) Applicant: Huawei Technologies Co., Ltd., Shenzhen (CN)

(72) Inventors: Xi Zhang, Beijing (CN); Wen Tong, Ottawa (CA); Xiaoyan Bi, Shanghai (CN); Jianglei Ma, Ottawa (CA)

(21) Appl. No.: 19/073,863

(22) Filed: Mar. 7, 2025

Related U.S. Application Data
(63) Continuation of application No. PCT/CN2022/118160, filed on Sep. 9, 2022.

(51) Int. Cl. H04B 7/06; H04L 5/00; H04W 64/00

(52) U.S. Cl. CPC H04B 7/06966; H04B 7/0626; H04L 5/0048; H04W 64/003

(57) ABSTRACT

Aspects of the present disclosure provide a polarization direction indication that may enable UE beam measurement/reporting in symbols carrying reference signals for beam measurement (e.g, SSB) on a first polarization direction with UE data transmission/reception in the same symbols on a second polarization direction. Aspects of the present disclosure also provided a resource mapping scheme for data (e.g., PDSCH) and associated demodulation reference signal (e g., DMRS).

### CROSS-REFERENCE TO RELATED APPLICATIONS

This application is a continuation of International Application No. PCT/CN2022/118160, filed on Sep. 9, 2022, the disclosure of which is hereby incorporated by reference in its entirety.

### TECHNICAL FIELD

The present disclosure relates generally to wireless communications, and in particular embodiments, performing data buffering and beam training in parallel with dual-polarized antennas in a wireless communication system.

### BACKGROUND

In Fifth Generation (5G) New Radio (NR), a synchronization signal—physical broadcast channel (SS-PBCH) block (SSB) is transmitted with one antenna port, i.e. antenna port p=4000 is used for transmission of primary synchronization signal (PSS), secondary synchronization signal (SSS), physical broadcast channel (PBCH) and demodulation reference signal (DM-RS) for PBCH. An antenna port is a virtual concept and is not necessarily equivalent to transmission on a given antenna. For example, a base station (BS) may use two antennas to transmit one antenna port. A user equipment (UE) may have no knowledge of antenna architecture at the base station or how such 1-port SSB is transmitted via one or more antennas at the base station.

At frequencies in the millimeter wave (mmWave) range (e.g., 26, 38, 39, 73 GHz) and the mid-band range (e.g., 3.5, 3.7, 4.7, 4.9 GHz), dual-polarized antennas are widely used at the base station and the UE. With dual-polarized antennas, two linearly polarized antennas are often superposed on a same location, but separated by about 90 degrees in the polarization direction, for example, vertical and horizontal polarization directions or ±45 degree slant polarization directions. With dual-polarized antennas, independent signals can be transmitted from antennas with different polarization directions. There may be multiple antennas corresponding to the same polarization direction, for example, the first and second groups of antennas for vertical and horizontal polarization directions or ±45 degree slant polarization directions, respectively. In this case, one antenna over vertical or −45-degree slant polarization direction may be superposed with one antenna over horizontal or ±45-degree slant polarization direction. It is also possible that the first and second groups of antennas for vertical and horizontal polarization directions or ±45 degree slant polarization directions are located separately, e.g., the first group of antennas at one location and the second group of antennas at another location. In such cases, the number of antennas in the first and the second groups of antennas can be same or different.

With 1-port SSB and dual-polarized antennas, typically the base station transmits a same SSB signal via dual-polarized antennas, and the UE also measures with dual-polarized antennas. In 5G NR, it is expected that a measured result should not be less than the result measured from either of the dual-polarized antennas at the UE when considered individually or polarized antennas at the UE over either polarization direction. The measured signals from the dual-polarized antennas at the UE may be compared or combined, and a decision of the exact manner of processing is left to the UE (e.g., maximum power, average power). As the same SSB signal is transmitted via dual-polarized antennas at the base station, the UE may not be able to tell which polarized antenna(s) of the base station or polarized antennas over which polarization direction the received signal is from. The base station may select one or multiple antennas with one polarization direction to transmit an SSB, but such selection is unknown to the UE.

FIG. 1 illustrates a portion of a network 10 that includes a base station 5 and a UE 20. The base station 5 is shown to have three beams 7a, 7b and 7c pointed to different directions in space. Each of the three beams 7a, 7b and 7c are actually two beams being transmitted or received in the same direction by dual-polarized antennas. For example, a first group of antennas on vertical polarization direction is used to generate one beam, while a second group of antennas on horizontal polarization direction is used to generate another beam pointing at the same direction in physical space but over a horizontal polarization direction. The symbol “+” shown on the three beams is in fact an indication that there is a beam in a vertical polarization direction (represented by the “|” symbol) and a beam in a horizontal polarization direction (represented by “−” symbol) that are overlapping. The UE 20 is shown to have two beams 22a and 22b pointed to different directions in space. Each of the two beams 22a and 22b includes two beams being transmitted or received in the same direction by dual-polarized antennas. For example, a first group of polarized antennas on vertical polarization direction is used to generate one beam, while a second group of polarized antennas on horizontal polarization direction is used to generate another beam pointing at the same direction in physical space but over horizontal polarization direction. The base station 5 and the UE 20 perform beam alignment and end up selecting base station beam 7b and UE beam 22a as a preferred beam pair for transmission or communication.

At mmWave frequencies, analog beamforming is typically adopted by both the base station and the UE in order to extend signal coverage. There is large resource overhead when performing beam sweeping at the base station side, e.g., the base station transmits 64 SSBs in every SSB period (e.g., 10 ms). Without knowledge of the base station polarization direction, the UE applies a same analog beam on the UE dual-polarized antennas, as discussed in above. Consequently, beam sweeping at the UE side results in large latency for beam-based initial access. After initial access, and when in connected mode, with the UE applying a same analog beam on dual-polarized antennas of the UE to perform beam measurements over orthogonal frequency domain multiplexing (OFDM) symbols carrying SSBs, where the applied analog beam is selected by the UE and unknown to the base station, the base station may be unable to schedule UE-specific data transmission on those OFDM symbols, which may cause frequent scheduling restrictions and data interruptions.

In 5G NR, it was proposed using multiple panels at the UE to form multiple receive beams to support simultaneous reception of SSB and physical downlink shard channel (PDSCH). The proposal was intended for a multi-transmit receive point (TRP) scenario as multi-panels at UE are facing different directions in physical space. This was not adopted due to high complexity and high power consumption for the UE.

Also for 5G NR, for a non-terrestrial network (NTN) scenario, it was proposed to include a method involving per-channel or per-signal indication of polarization type selected from amongst left-handed circular polarization (LHCP), right-handed circular polarization (RHCP), or linear polarization (LP). In particular, it was proposed to use downlink control information (DCI) to indicate polarization type of scheduled PDSCH, which may be dynamically selected from amongst the supported polarization types. It was also considered to multiplex signals in different cells by using different polarization types. For example, a first and a second base stations may transmit two signals, e.g., SSB and PDSCH, with LHCP and RHCP, respectively, and simultaneously (i.e., over the same time and frequency resources), where the polarization type for PDSCH is dynamically indicated by the scheduling downlink control indication (DCI). This scheme was also not adopted due to increased uncertainty on inter-cell interference (e.g., potential interference from PDSCH transmitted by the second base station with RHCP to SSB transmitted by a third base station also with RHCP (as there are typically more than two base stations in a network), which would then impact UEs performing initial access with the third base station. In addition, such solution is unable to reduce data interruptions caused by UE beam training from one UE perspective.

For a single base station communicating with a single-panel UE, there are frequent interruptions of UE-specific data transmission over OFDM symbols carrying SSBs (also referred to as SSB symbols). For multiple base stations communicating with a multi-antenna panel UE, while it may be possible to reduce interruptions on UE-specific data transmissions, multiple antenna panels are needed at the UE, which results in higher complexity and higher power consumption. For multiple base stations communicating with multiple UEs with different polarization types, there may be an inability to reduce interruptions of UE-specific data transmissions over SSB symbols from one UE perspective.

Methods and devices to address the above indicated drawbacks would be helpful for communication systems.

### SUMMARY

Aspect of the present disclosure provide solutions to overcome the shortcomings described above, as well as specific methods for reducing interruptions on UE-specific data transmission during beam training.

In some aspects of the disclosure, there is provided a method involving: transmitting a polarization direction indication indicating the polarization direction for UE beam measurement in symbols carrying reference signals for beam measurement or UE data transmission or reception in symbols carrying reference signals for beam measurement.

In some embodiments, the reference signals for beam measurement is one of: synchronization signal—physical broadcast channel (SS-PBCH) block (SSB); channel state information reference signal (CSI-RS); tracking reference signal (TRS); or positioning reference signal (PRS).

In some embodiments, the polarization direction indication includes at least one of an index of a reference signal for beam measurement or an antenna port index identifying an antenna port of two antenna ports used for the transmission of reference signal for beam measurement, where the two antenna ports correspond to first and second polarization directions of antennas at the base station or first and second polarization directions relative to a reference plane.

In some embodiments, the UE beam measurement includes at least one of reference signal received power (RSRP) measurement or signal-to-interference plus noise ratio (SINR) measurement; and the UE data reception involves at least one of physical downlink control channel (PDCCH) reception or physical downlink shared channel (PDSCH) reception.

In some embodiments, the polarization direction indication indicates a first polarization direction as the polarization direction for receiving UE data in symbols carrying reference signals for beam measurement.

In some embodiments, the method further involves at least one of: receiving UE data on symbols carrying reference signals for beam measurement on the first polarization direction; or performing UE beam measurement on symbols carrying reference signals for beam measurement on a second polarization direction.

In some embodiments, the polarization direction indication indicates the first polarization direction as the polarization direction for UE beam measurement in symbols carrying reference signals for beam measurement.

In some embodiments, the method further involves at least one of: performing UE beam measurement on symbols carrying reference signals for beam measurement on the first polarization direction; or receiving UE data on symbols carrying reference signals for beam measurement on a second polarization direction.

In some embodiments, the method further involves transmitting an indication to the UE to configure the UE to alternate polarization direction used for receiving UE data among the first and second polarization directions over even and odd-indexed periods for reference signals for beam measurement.

In some embodiments, the method further involves transmitting an indication to configure the UE to alternate polarization direction used for UE beam measurement among the first and second polarization directions over even and odd-indexed periods for reference signals for beam measurement.

In some embodiments, the method further involves transmitting UE data in symbols carrying a first reference signal for beam measurement where the UE data is in quasi-co-location (QCL) with a second reference signal for beam measurement.

In some embodiments, the first and second polarization directions are one of: vertical and horizontal polarization directions; or horizontal and vertical polarization directions; or −45 and +45 degree slant polarization directions; or +45 and −45 degree slant polarization directions.

In some embodiments, the transmitting UE data in symbols carrying reference signals for beam measurement further involves at least one of: transmitting 1-port demodulation reference signal (DMRS) on the first symbol among the symbols carrying one reference signal for beam measurement; or transmitting 2-port DMRS on the first symbol after the symbols carrying one reference signal for beam measurement.

In some embodiments, the 1-port DMRS is transmitted over the same polarization direction as the polarization direction indicated for transmitting or receiving UE data in symbols carrying reference signals for beam measurement.

In some embodiments, the transmitting UE data in symbols carrying reference signal for beam measurement further involves at least one of: not mapping or transmitting PDSCH in one or more symbols before or after the symbols carrying one reference signal for beam measurement; or not mapping or transmitting PDSCH in one or more subcarrier, resource element, or resource block in frequency domain below or above resource blocks carrying one reference signal for beam measurement.

In some aspects of the disclosure, there is provided a device including: a processor and a computer-readable storage media. The computer-readable storage media having stored thereon, computer executable instructions, that when executed by the processor, perform a method as described above or detailed below.

In some embodiments, the device is a base station.

In some aspects of the disclosure, there is provided a method involving: receiving, by a UE, a polarization direction indication indicating the polarization direction for UE beam measurement in symbols carrying reference signals for beam measurement or UE data transmission or reception in symbols carrying reference signals for beam measurement.

In some embodiments, the reference signals for beam measurement is one of: SSB; CSI-RS; TRS; or PRS.

In some embodiments, the polarization direction indication includes at least one of an index for a reference signal for beam measurement or an antenna port index identifying an antenna port of two antenna ports used for the transmission of reference signal for beam measurement, where the two antenna ports correspond to first and second polarization directions of antennas at the base station or first and second polarization directions relative to a reference plane.

In some embodiments, the UE beam measurement includes at least one of RSRP measurement or SINR measurement; and the UE data reception includes at least one of PDCCH reception or PDSCH reception.

In some embodiments, the polarization direction indication indicates the first polarization direction as the polarization direction for receiving UE data in symbols carrying reference signals for beam measurement.

In some embodiments, the method further involves at least one of: receiving UE data on symbols carrying reference signals for beam measurement on the first polarization direction; or performing UE beam measurement on symbols carrying reference signals for beam measurement on the second polarization direction.

In some embodiments, the polarization direction indication indicates the first polarization direction as the polarization direction for UE beam measurement in symbols carrying reference signals for beam measurement.

In some embodiments, the method further involves at least one of: performing UE beam measurement on symbols carrying reference signals for beam measurement on the first polarization direction; or receiving UE data on symbols carrying reference signals for beam measurement on the second polarization direction.

In some embodiments, the method further involves receiving an indication to configure the UE to alternate polarization direction used for receiving UE data among the first and second polarization directions over even and odd-indexed periods for reference signals for beam measurement.

In some embodiments, the method further involves receiving an indication to configure the UE to alternate polarization direction used for UE beam measurement among the first and second polarization directions over even and odd-indexed periods for reference signals for beam measurement.

In some embodiments, the method further involves receiving UE data in symbols carrying a first reference signal for beam measurement where the UE data is in QCL with a second reference signal for beam measurement.

In some embodiments, the UE sets a maximum number of layers for PDSCH reception in symbols carrying reference signals for beam measurement equal to one.

In some embodiments, the first and second polarization directions are one of: vertical and horizontal polarization directions; or horizontal and vertical polarization directions; or −45 and +45 degree slant polarization directions; or +45 and −45 degree slant polarization directions.

In some embodiments, receiving the UE data in symbols carrying reference signals for beam measurement further involves at least one of: receiving a 1-port DMRS on the first symbol among the symbols carrying one reference signal for beam measurement; or receiving a 2-port DMRS on the first symbol after the symbols carrying one reference signal for beam measurement.

In some embodiments, the 1-port DMRS is received over the same polarization direction as the polarization direction indicated for UE data transmission or reception in symbols carrying reference signals for beam measurement.

In some embodiments, the UE data reception in symbols carrying reference signals for beam measurement further involves at least one of: assuming PDSCH is not mapped on one or multiple symbols before or after the symbols carrying one reference signal for beam measurement; or assuming PDSCH is not mapped on one or multiple subcarrier(s), resource element(s), or resource block(s) in frequency domain below or above the resource blocks carrying one reference signal for beam measurement.

In some aspects of the disclosure, there is provided a device including: a processor and a computer-readable storage media. The computer-readable storage media having stored thereon, computer executable instructions, that when executed by the processor, perform a method as described above or detailed below.

In some embodiments, the device is a user equipment.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram illustrating transmission and reception for 1-port SSB with dual-polarized antennas.

FIG. 2A is a schematic diagram of a communication system in which embodiments of the disclosure may occur.

FIG. 2B is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 is a schematic diagram illustrating two concurrent UE beams to measure 2-port SSBs.

FIG. 6 is a schematic diagram illustrating a beam swept transmission of SSBs from a base station according to an aspect of the present disclosure.

FIG. 7 is a schematic diagram illustrating UE data buffering in SSB symbols with polarization direction indication for data buffering from the base station according to an aspect of the present disclosure.

FIG. 8 is a schematic diagram illustrating of UE beam training with single polarization direction according to an aspect of the present disclosure.

FIG. 9 illustrates an example of PDSCH and demodulation reference signal (DMRS) mapping scheme for slot-based scheduling in SSB-containing slots in accordance with embodiments of the present disclosure.

FIG. 10 is an example of a signaling flow diagram for signaling between a base station and a UE in accordance with embodiments of the present disclosure.

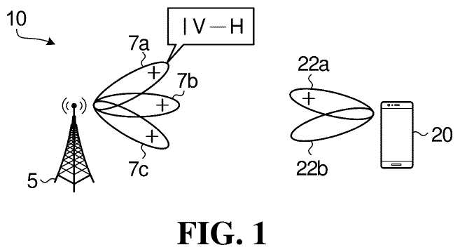

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

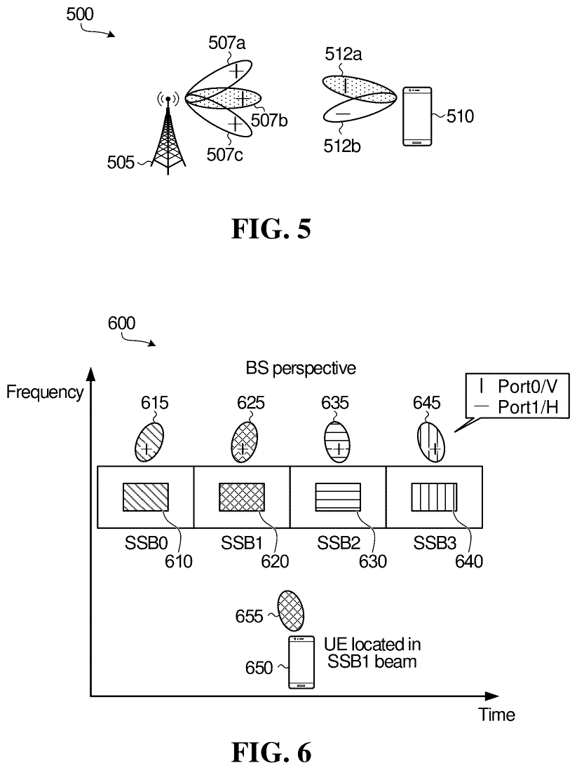

In a co-pending application (Assignee Reference 92019493PCT01), the Assignee of both that application and the present application described a method of implementing 2-port SSB to exploit dual-polarized antennas for reducing latency and/or overhead for beam-based initial access, especially for mmWave frequency bands. With such a 2-port SSB, each SSB-port is transmitted via one or more base station antenna over one polarization direction (e.g., −45 or +45 degree slant polarization direction) or over one polarization direction relative to a reference plane, for example the surface of the earth (e.g., vertical or horizontal polarization direction). The dual-polarized antennas at the base station may apply the same or different beamforming weights (e.g., same or different beams). For a case where the base station applies the same beamforming weight (e.g., same beam) on the base station antennas over two polarization directions, with a differentiation of polarization directions of base station antennas using 2-port SSB and such knowledge provided to the UE, the UE may be able to decouple the UE dual-polarized antennas and measure two UE receive beams simultaneously, as illustrated in FIG. 5. In this way, the latency for beam-based initial access may be reduced. It is worth noting that the base station and the UE are capable of transmitting and receiving with different beamforming weights using antennas over two polarization directions.

FIG. 5 illustrates a portion of a network 500 that includes a base station 505 and a UE 510. Three base station transmit beams 507a, 507b and 507c are shown. Each of the base station transmit beams 507a, 507b and 507c are shown to include two polarization directions indicated by the overlapping horizontal and vertical lines that are represented by the “+” symbol. The UE 510 is shown to have two concurrent receive beams over two polarization directions. A first beam 512a is shown to transmit or receive over vertical polarization direction (|) and a second beam 512b is shown to transmit or receive over horizontal polarization direction (−). The two polarization directions at the UE may shift as the UE changes its orientation or switches receiving panels or antennas. The two concurrent UE receive beams 512a and 512b may help reduce latency for UE-side beam sweeping during initial access procedure.

In 5G NR, in radio resource control (RRC) CONNECTED mode, a maximum number of multiple-input multiple-output (MIMO) layers are pre-configured for a UE. Such pre-configuration enables the UE to know what to expect and how to buffer data (e.g., using how many antennas). The scheduled number of MIMO layers may then be dynamically indicated (i.e., UE buffers first, then detects if there is data for the UE). Similarly, in RRC CONNECTED mode, SSBs to be measured/reported are also pre-configured for a UE. Such pre-configuration enables the UE to know which SSBs should be measured and selectively reported in an effort to deal with the UE movement across base station beams corresponding to different SSB(s) or channel state information reference signals (CSI-RSs). An active beam pair for data reception, which is likely selected among those reported by the UE, may then be dynamically indicated to the UE via a transmission configuration indicator (TCI) state carried over at least one of RRC, media access control—control element (MAC-CE), or DCI. Included within the indicated TCI state, there is provided a reference signal, such as an SSB or a CSI-RS, where the CSI-RS may be quasi co-located (QCLed) to an SSB in terms of QCL-TypeD, which may help the UE determine receive beamforming or beam. SSB is a collection of one or more of synchronization signals (i.e., PSS and SSS), reference signals (i.e., PBCH-DMRS), and physical channel (i.e., PBCH), where the SSS may be used for beam measurement, without any ambiguity. SSB may be also referred to as one type of reference signal.

Aspects of the present disclosure may exploit use of dual-polarized antennas at the base station and the UE to enable both data reception and beam measurement to occur in OFDM symbols carrying SSB, thereby enabling multiplexing of UE-specific data transmission and beam measurement over polarization domain. In some embodiments, the UE beam measurement includes at least one of reference signal received power (RSRP) measurement or signal-to-interference plus noise ratio (SINR) measurement. In some embodiments, the UE data reception comprises at least one of physical downlink control channel (PDCCH) reception or physical downlink shared channel (PDSCH) reception.

In some embodiments, dual-polarized antennas are included at a base station and at least one panel of the UE. In some embodiments methods are provided for the base station to provide polarization direction-related configuration information to enable UE data reception or beam measurement on a first group of UE antennas over one polarization direction or over a first polarization direction relative to a reference plane (for example, the surface of the earth), so that a second group of UE antennas or a second polarization direction relative to a reference plane may be used for other purposes (e.g., beam measurement or data reception). In some embodiments, there is provided resource mapping scheme for data (e.g., PDSCH) and an associated demodulation reference signal (e.g., DMRS) to facilitate slot-based scheduling in slots containing beam measurement resources (e.g., SSB).

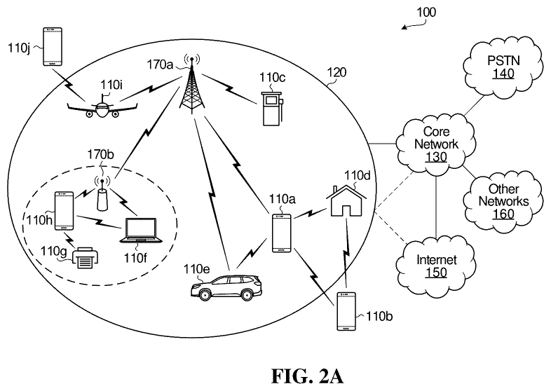

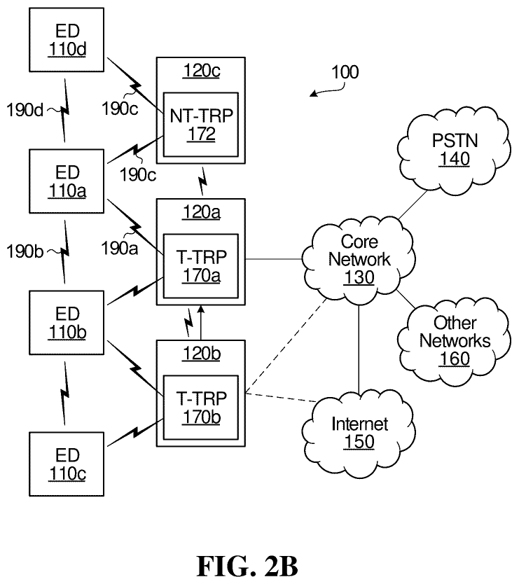

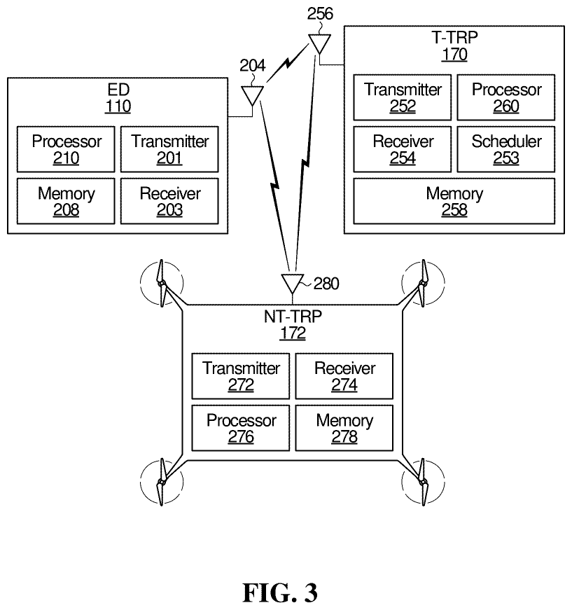

FIGS. 2A, 2B, and 3 following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIGS. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

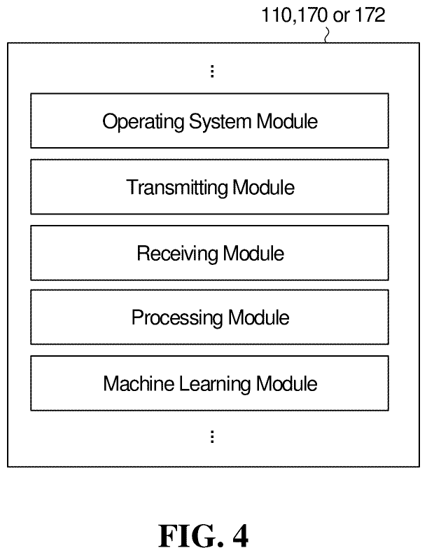

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency. AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Aspects of the present disclosure may provide a polarization direction indication that may enable UE data transmission/reception in OFDM symbols carrying synchronization signal—physical broadcast channel (SS-PBCH) block (SSB) on a first polarization direction with beam measurement in the same OFDM symbols, but on a second polarization direction. In some embodiment, multiple OFDM symbols may occur over a slot or a mini-slot.

Aspects of the present disclosure may also provide a polarization direction indication that may enable UE beam measurement/reporting in OFDM symbols carrying SSB on a first polarization direction with UE data transmission/reception in the same OFDM symbols, but on a second polarization direction.

Aspects of the present disclosure may provide a mapping scheme of PDSCH and associated DMRS on a time and frequency resource grid to facilitate slot-based data scheduling where the slot contains OFDM symbols carrying SSB, and there may be a change of the number of PDSCH layers and a change of the number of DMRS ports within the slot. In some embodiments, there is additional DMRS on the first OFDM symbol after the OFDM symbols carrying SSB. For example, the last OFDM symbol carrying SSB is identified with an index n, and therefore additional DMRS is mapped on the OFDM symbol with index n+1. In some embodiments, there is additional DMRS on a second OFDM symbol after the OFDM symbols carrying SSB. For example, the last OFDM symbol carrying SSB is identified with an index n, and therefore additional DMRS is mapped on the OFDM symbol with index n+2. In such a case, PDSCH may not be mapped on an OFDM symbol with index n+1. The OFDM symbol with index n+1 may be reserved as a gap in the time domain for the UE to adjust reception behavior such as preparing dual-polarized antennas of the UE and adjusting automatic gain control.

Aspects of the present disclosure may provide methods for base station transmission beamforming that enables transmission of UE-specific data in OFDM symbols carrying SSB, wherein in OFDM symbols carrying an SSB which is transmitted on a first beam that is different from a second beam that is to be used for data transmission towards a UE, the base station may use an additional panel or transceiver unit (TXRU) to transmit data on the second beam towards the UE, in addition to the panel or TXRU used for SSB transmission on the first beam.

In some embodiments, a polarization direction indication is provided to facilitate UE data transmission/reception in OFDM symbols carrying SSB, over which UE beam measurement is also expected to occur. In addition to configuration information for facilitating reception of UE data such as a maximum number of MIMO layers (e.g., represented by a parameter maxMIMO-Layers), the base station may provide a polarization direction indication for data transmission in OFDM symbols carrying SSB. UE data reception may include buffering the received signal and detecting whether there is data for this UE. With 2-port SSB as described above, each SSB may be transmitted with two antenna ports. In some embodiments, each antenna port of a 2-port SSB is transmitted via one or multiple base station antenna(s) on one polarization direction. For example, a first port may be transmitted via one or multiple vertically polarized antenna(s) and a second port may be transmitted via one or multiple horizontally polarized antenna(s). In another example, the first port may be transmitted via one or multiple −45 degree slantingly polarized antenna(s) and the second port may be transmitted via one or multiple +45 degree slantingly polarized antenna(s).

A polarization direction indication may be provided in the form of an SSB index where one SSB corresponds to one polarization direction or an SSB-port index where one SSB port corresponds to one polarization direction of dual-polarized antennas at a base station or one polarization direction relative to a reference plane. In some embodiments, the configuration information for facilitating UE data reception may include identification of a base station beam or a UE beam or a base station and UE beam pair. In some embodiments, configuration information for facilitating UE data reception may include a quasi-colocation (QCL) indication. An example of indication of a beam or a quasi-colocation (QCL) indication may include a TCI state containing CSI-RS, which is QCLed to a particular SSB, representing an active beam pair for data transmission. More generally, it may be considered that, a UE is receiving data in OFDM symbols carrying a first SSB or a first SSB port, where the received UE data is in quasi-co-location (QCL) with a second SSB or a second SSB port.

FIG. 6 illustrates a time and frequency resource plane 600 that is used to transmit SSBs from a base station, for which time is represented on the horizontal axis and frequency is represented on the vertical axis. Four SSB, i.e., SSB0, SSB1, SSB2, SSB3, where each SSB is transmitted on 2 antenna ports, are shown each occupying a respective portion 610, 620, 630, 640 of the time and frequency resource plane 600. Above the four portions 610, 620, 630, 640 of the time and frequency resource plane 600 used for each SSB, there is illustrated a representation of four base station transmit beams 615, 625, 635, 645, each having a particular directionality associated with a respective portion of the time and frequency resource plane 600. This directionality is intended to suggest directions for transmit beams used by the base station. In some embodiments, each beam may be transmitted by dual-polarized antennas at the base station using a 2-port SSB. Each of the transmit beams 615, 625, 635, 645 are shown to include two polarization directions indicated by overlapping horizontal (−) and vertical (|) lines, collectively represented by the “+” symbol. Also shown below the four portions 610, 620, 630, 640 of the time and frequency resource plane 600 used for SSBs, there is illustrated a representation of a UE 650 and a UE beam 655. The UE beam 655 is shown below the portion 620 of the time and frequency resource plane 600 that base station transmits SSB1. The UE 650 may have previously measured multiple SSBs and reported SSB1 as the SSB having a highest RSRP, and the base station may have indicated to the UE 650 to receive data from the base station using a UE beam 655 corresponding to SSB1 (such as indicating that PDCCH or PDSCH is in QCL to SSB1 or a CSI-RS which is in QCL to SSB1). In this case, the base station beam 625 and UE beam 655 is considered as the active beam pair between the base station and the UE for data transmission.

In addition to such beam indication, the base station further indicates to the UE 650 the polarization direction for data transmission in OFDM symbols carrying SSB, such as port #1 of SSB1 that corresponds to horizontal polarization direction or port #0 of SSB1 that corresponds to vertical polarization direction. With such a polarization direction indication from the base station, the UE 650 may buffer a signal in OFDM symbols carrying SSB1 with one or more antennas on a corresponding polarization direction and then detect whether there is PDSCH for this UE.

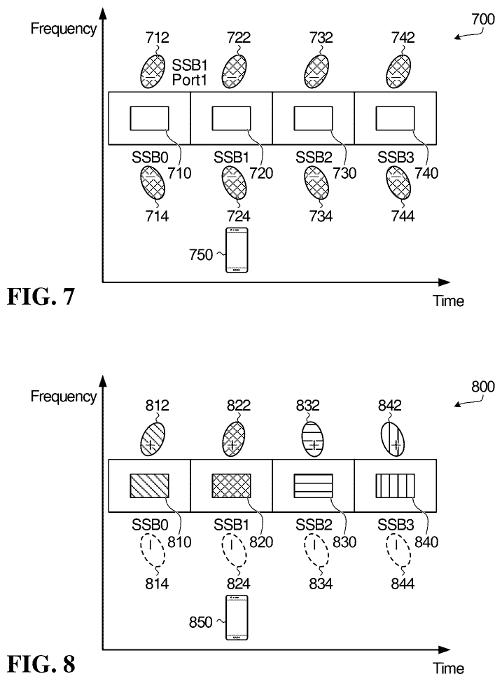

FIG. 7 illustrates a time and frequency resource plane 700 seen from the UE perspective after being provided with a polarization direction indication for data transmission or reception in OFDM symbols carrying SSBs, for which time is represented on the horizontal axis and frequency is represented on the vertical axis. Four portions 710, 720, 730, 740 are shown each occupying a portion of the time and frequency resource plane 700. In FIG. 7, there are four base station beams 712, 722, 732, and 742, having the same or a similar directionality, in each of the portions 710, 720, 730 and 740 of the time and frequency resource plane 700. This indicates that in OFDM symbols carrying multiple SSBs, the UE assumes the data transmitted from the base station is in TypeD QCL with SSB1 and under the same polarization direction as port #1 of SSB1, i.e., horizontal polarization direction indicated by the horizontal lines (−). Also in FIG. 7, four UE beams 714, 724, 734, and 744 are shown below the portions 710, 720, 730 and 740 of the time and frequency resource plane 700. Each UE beam 714, 724, 734, and 744 is shown having the same or a similar directionality for receiving the SSB1 and with a horizontal polarization direction indicated by the horizontal lines (−). This indicates that in OFDM symbols carrying multiple SSBs, the UE applies the same receive beam that was used to receive SSB1 to receive data over the indicated polarization direction. In some embodiments, when the UE has one TXRU over one polarization direction, the UE 750 assumes a parameter defining a maximum number of MIMO layers (i.e. maxMIMO-Layers) in OFDM symbols carrying SSB is set to 1, as the UE is performing data buffering and reception over only one polarization direction. In some embodiments, when the UE uses multiple TXRUs over one polarization direction (e.g., on the same UE panel), the UE 750 assumes a parameter defining a maximum number of MIMO layers (i.e., maxMIMO-Layers) in OFDM symbols carrying SSB reduces to half of the pre-configured value, as the UE is performing data buffering and reception over only one polarization direction.

After being configured with the polarization direction indication for data transmission or reception in OFDM symbols carrying SSB, with dual-polarized antennas at the UE, the UE may buffer and/or receive data in OFDM symbols carrying SSB over a first polarization direction indicated in the polarization direction indication (e.g., using antennas on the first polarization direction to buffer and/or receive data), and the UE may perform beam measurement over the second polarization direction (e.g., using antennas on the second polarization direction to measure different UE beams).

FIG. 8 illustrates a time and frequency resource plane 800 seen from the UE perspective after being provided with polarization direction indication for data transmission or reception in OFDM symbols carrying SSBs, for which time is represented on the horizontal axis and frequency is represented on the vertical axis. Four portions 810, 820, 830, 840 are shown each occupying a portion of the time and frequency resource plane 800. In FIG. 8, there are four base station beams 812, 822, 832, and 842 having different directionality, shown above each portion 810, 820, 830, 840 of the time and frequency resource plane 800. Each base station beam 812, 822, 832, and 842 is shown transmitting a different SSB, i.e., SSB0, SSB1, SSB2, and SSB3, respectively, where each SSB is transmitted on 2 antenna ports. The two antenna ports are represented in the form of the overlapping horizontal line “−” and vertical line “|” that collectively appear as the “+” symbol. Four UE beams 814, 824, 834, and 844 are shown below the portions 810, 820, 830, 840 of the time frequency resource plane 800 having a same polarization direction represented by the vertical line “|”. The four UE beams 814, 824, 834, and 844 are being used for beam measurement in OFDM symbols carrying the SSBs. In some embodiments, the particular UE beam to be used for beam measurement may be left to UE implementation, and therefore may be unknown to the base station represented by dashed ellipses. In some embodiments, when the UE 850 is performing beam measurement over one polarization direction or with UE antennas on one polarization direction, for robustness, the UE 850 may still measure both SSB ports from a 2-port SSB. In this way, parallel data reception and beam measurement may be enabled, thereby reducing interruptions on UE data reception during beam measurement.

Overlaying the time and frequency resource planes 700 and 800 shown in FIGS. 7 and 8, it can be seen how the UE may receive data on OFDM symbols carrying SSB in a first polarization direction (e.g., horizontal polarization direction as shown in FIG. 7) and how the UE may perform beam measurement on OFDM symbols carrying SSB in a second polarization direction (e.g., vertical polarization direction as shown in FIG. 8).

In some embodiments, the UE may be configured with a polarization direction indication for beam measurement using 2-port SSB. Such indication may be provided in the form of an SSB port index, which is associated with a polarization direction (e.g., porto for vertical polarization direction or port1 for horizontal polarization direction or vice versa, porto for +45 degree slant polarization direction or port1 for −45 degree polarization direction or vice versa). With such a polarization direction indication configured by the base station, the UE may decouple the UE dual-polarized antennas into two polarization directions. The UE may then perform beam measurement over the polarization direction indicated by the base station using UE antennas corresponding to the indicated polarization direction (e.g., vertical or −45 degree slant polarization direction). The UE may then receive data with UE antennas corresponding to the remaining polarization direction (e.g., horizontal or +45 slant polarization direction), thereby enabling parallel data reception and beam measurement.

In some embodiments, the base station may provide an indication to the UE that the UE may alternate the polarization direction amongst the two polarization directions for data reception over even and odd-indexed SSB periods. For example, the UE may assume vertical or −45 degree slant polarization direction for data reception in even-indexed SSB periods and horizontal or +45 degree slant polarization direction for data reception in odd-indexed SSB periods, and vice versa. This may result in additional robustness.

In some embodiments, the base station may provide an indication to the UE that the UE may alternate the polarization direction amongst the two polarization directions for beam measurement over even and odd-indexed SSB periods. For example, the UE may assume vertical or −45 degree slant polarization direction for beam measurement in even-indexed SSB periods and horizontal or +45 degree slant polarization direction for beam measurement in odd-indexed SSB periods, and vice versa. This may result in additional robustness.

In some embodiments, in OFDM symbols carrying one SSB, the base station may use an additional panel or TXRU to transmit data with a first beam towards a UE in addition to the panel or TXRU used for transmitting the SSB with a second beam towards a different direction in physical space. This may enable the base station to transmit data in OFDM symbols containing one SSB where the targeted UE of the transmitted data may not be located within the confines of the same beam as the SSB.

Some embodiments of the disclosure may enable parallel data reception and beam measurement over OFDM symbols carrying SSB exploiting dual-polarized antennas at the base station and the UE, thereby avoiding interruptions on data transmission during beam measurement.

Some embodiments of the disclosure may improve spectrum efficiency as OFDM symbols carrying SSB may also be used for transmitting data, and may reduce complexity and power consumption by not requiring multiple base stations or TRPs or multiple panels at the UE.

Some embodiments provide a method to map PDSCH and associated DMRS on a time and frequency resource plane to facilitate slot-based scheduling and UE data reception in slots containing OFDM symbols carrying SSB. In some embodiments, instead of a slot, the time unit may be a subframe or a bundle of slots or an OFDM symbol or a bundle of OFDM symbols.

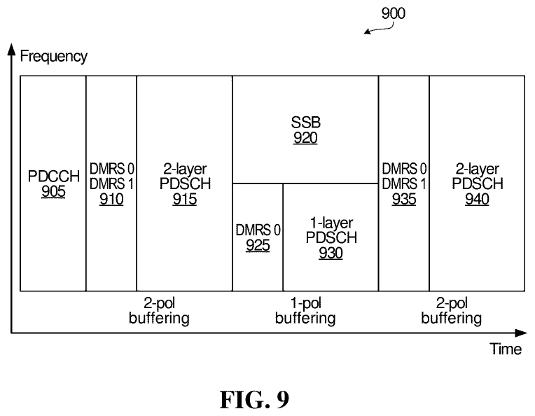

FIG. 9 illustrates an example time and frequency resource plane 900 in which time is represented on the horizontal axis and frequency is represented on the vertical axis. The time and frequency resource plane 900 includes physical downlink control channel (PDCCH), demodulation reference signal (DMRS), physical downlink shared channel (PDSCH), and synchronization signal—physical broadcast channel (SS-PBCH) block (SSB). A first portion 905 of the time and frequency resource plane 900 is shown to include PDCCH. A second portion 910 of the time and frequency resource plane 900, which occupies a different time portion than the first portion 905, is shown to include 2-port DMRS, i.e. DMRS 0 and DMRS 1, to facilitate channel estimation at the UE for the two ports that are used to transmit 2-layer PDSCH in a third portion 915. The third portion 915 of the time and frequency resource plane 900, which occupies a different time portion than the first and second portions 905 and 910, is shown to include 2-layer PDSCH, which allows 2-layer PDSCH to be received at the UE, possibly with each PDSCH layer corresponding to one polarization direction. A fourth portion 920 of the time and frequency resource plane 900, which occupies a different time portion than the first, second and third portions 905, 910 and 915, is shown to include SSB, which allows beam measurement to enable beam training or beam tracking that may be used to support cross-beam movement or mobility in multi-beam systems. A fifth portion 925 of the time and frequency resource plane 900, which occupies a different time portion than the first, second and third portions 905, 910 and 915, but an overlapping time portion with the fourth portion 920, is shown to include 1-port DMRS, which allows early channel estimation in OFDM symbols carrying SSB to enable timely update of channel estimation after switching to 1-layer PDSCH reception. FIG. 9 shows the 1-port DMRS on the first OFDM symbol of the OFDM symbols carrying SSB, but it should be understood that this is merely an example and is not intended to limit various other arrangements that may be possible. A sixth portion 930 of the time and frequency resource plane 900, which occupies a different time portion than the first, second, third and fifth portions 905, 910, 915 and 925, but an overlapping time portion with the fourth portion 920, is shown to include 1-layer PDSCH. A seventh portion 935 of the time and frequency resource plane 900, which occupies a different time portion than the first, second, third, fourth, fifth and sixth portions 905, 910, 915, 920, 925 and 930, is shown to include 2-port DMRS, i.e. DMRS 0 and DMRS 1, to facilitate channel estimation at the UE for the two ports that are used to transmit 2-layer PDSCH in an eighth portion 940. The eighth portion 940 of the time and frequency resource plane 900, which occupies a different time portion than first, second, third, fourth, fifth, sixth, and seventh portions 905, 910, 915, 920, 925, 930 and 935, is shown to include 2-layer PDSCH, which allows 2-layer PDSCH to be received at the UE, possibly with each PDSCH layer corresponding to one polarization direction.

In some embodiments, for slots containing OFDM symbols carrying SSB, 2-layer PDSCH may be mapped on OFDM symbols before or after the OFDM symbols carrying SSB. In addition, the 1-layer PDSCH may be mapped on OFDM symbols carrying SSB. Therefore, in some implementations there may be a change in the number of layers used for PDSCH within one slot, i.e. as shown in FIG. 9 going from the third portion 915 having 2-layer PDSCH to the sixth portion 930 having 1-layer PDSCH or going from the sixth portion 930 having 1-layer PDSCH to the eighth portion 940 having 2-layer PDSCH. In some embodiments, instead of the time unit being a slot, the time unit may be a subframe or a bundle of slots or an OFDM symbol or a bundle of OFDM symbols. In some embodiments, when mapping PDSCH to OFDM symbols carrying SSB, PDSCH is not mapped to the resource blocks (RBs) occupied by SSB, or alternatively the RBs occupied by SSB are skipped when mapping PDSCH to virtual or physical RBs. Here an RB is defined as a number (such as 12) of consecutive subcarriers in the frequency domain.

In some embodiments, for slots containing OFDM symbols carrying SSB, when 2-layer PDSCH is scheduled, there may be 2-port DMRS that precedes the 2-layer PDSCH to facilitate channel estimation at the UE, i.e., as shown in FIG. 9 by 2-port DMRS in second portion 910 that precedes the 2-layer PDSCH in third portion 915. In some embodiments, there may be 1-port DMRS that precedes 1-layer PDSCH to facilitate channel estimation in OFDM symbols carrying SSB, to enable timely update of channel estimation after switching to 1-layer PDSCH reception, i.e., as shown in FIG. 9 by 1-port DMRS in fifth portion 925 that precedes the 1-layer PDSCH in sixth portion 930. In some embodiments, instead of the time unit being a slot, the time unit may be a subframe or a bundle of slots or an OFDM symbol or a bundle of OFDM symbols.

In some embodiments, there may be 2-port DMRS in an OFDM symbol after the SSB when changing back to 2-layer PDSCH reception, thereby enabling a timely update of channel estimation. Therefore, there is a change in the number of DMRS ports within one slot, i.e. as shown at the second portion 910 having 2-port DMRS, the fifth portion 925 having 1-port DMRS, and the seventh portion 935 having 2-port DMRS. In some embodiments, instead of the time unit being slot, the time unit may be a subframe or bundle of slots or an OFDM symbol or a bundle of OFDM symbols.

In some embodiments, for OFDM symbols before or after SSB, the UE may use antennas corresponding to both polarization directions for data reception and thereby support 2-layer PDSCH reception. For OFDM symbols carrying SSB, the UE may use antennas corresponding to a first polarization direction for data reception which supports 1-layer PDSCH reception and may use antennas corresponding to a second polarization direction to perform beam measurement for beam training or beam tracking to support cross-beam movement or mobility in multi-beam systems.

In some embodiments, the base station may reserve gaps in at least one of the time domain or the frequency domain. A gap in time domain may allow for time for the UE to adjust receiving antennas, such as preparing antennas corresponding to one polarization direction, to receive data and/or preparing antennas corresponding to the other polarization direction to perform beam measurement. A gap in frequency domain may help mitigate interference. In some embodiments, as one way of implementing a gap in time domain, there may be one or more OFDM symbol between 2-layer PDSCH and 1-port DMRS or SSB or between 1-layer PDSCH or SSB and 2-port DMRS, which is not used or is skipped when mapping PDSCH to the time and frequency resource grid in a slot containing OFDM symbols carrying SSB. In some embodiments, as one way of implementing a gap in frequency domain, there may be a number of subcarriers or resource blocks (RBs) between SSB and 1-port DMRS or 1-layer PDSCH that are not used or are skipped when mapping PDSCH to the time and frequency resource grid in a slot containing OFDM symbols carrying SSB. This may suppress potential interference between SSB and PDSCH, such as when PDSCH and SSB are transmitted over different TXRUs. In some embodiments, instead of the time unit being a slot, the time unit may be a time unit such as a subframe or a bundle of slots or an OFDM symbol or a bundle of OFDM symbols.

In some embodiments, the 1-port DMRS mentioned in embodiments described above may instead be N-port DMRS, and 2-port DMRS mentioned in embodiments described above may instead be 2N-port DMRS, where N is an integer greater than 1. In some embodiments, the 1-layer PDSCH mentioned in embodiments described above may instead be M-layer PDSCH, and 2-layer PDSCH mentioned in embodiments described above may instead be 2M-layer PDSCH, where M is an integer greater than 1. In some embodiments, the value of N may be equal to value of M. Such embodiments may occur when the UE has more than one TXRU over one polarization direction.

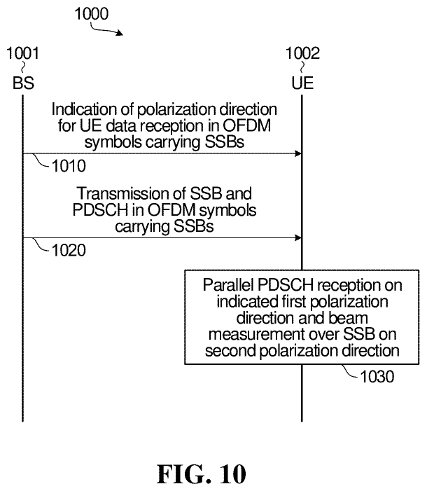

FIG. 10 is a signal flow diagram 1000 that illustrates signaling or signal transmission and reception between a base station (BS) 1001 and a UE 1002 in accordance with embodiments of the present disclosure. At step 1010, the base station 1001 transmits configuration that includes an indication of polarization direction for UE data transmission or reception in OFDM symbols carrying SSBs. In some embodiments, the configuration information transmitted by the base station may include a polarization direction indication which may be provided in the form of an SSB index where one SSB corresponds to one polarization direction or an SSB-port index where one SSB port corresponds to one polarization direction of dual-polarized antennas at a base station or one polarization direction relative to a reference plane. In some embodiments, configuration information may include identification of a base station beam or a UE beam or a base station and UE beam pair. In some embodiments, the configuration information transmitted by the base station may include an indication that the UE may alternate the polarization direction amongst the two polarization directions for data reception over even and odd-indexed SSB periods. In some embodiments, the base station may provide an indication to the UE that the UE may alternate the polarization direction amongst the two polarization directions for beam measurement over even and odd-indexed SSB periods.

At step 1020, the base station 1001 transmits SSB and PDSCH in OFDM symbols carrying SSBs in a manner consistent with the configuration information sent in step 1010. For example, the transmission of SSB and PDSCH in OFDM symbols may be consistent with the time and frequency resource plane 900. At step 1030, the UE 1002 performs parallel PDSCH reception on the indicated first polarization direction and beam measurement over SSB on second polarization direction, or vice versa.

In the embodiments above, for illustration purpose, SSB is a reference signal for beam measurement. However, it should be understood that other types of reference signals may be used for beam measurement. Other examples of reference signals for beam measurement include channel state information reference signal (CSI-RS), tracking reference signal (TRS), or positioning reference signal (PRS). Furthermore, while SSB in 5G NR includes all of PSS, SSS, PBCH, and PBCH-DMRS, in the scope of this disclosure, the SSB may include some or all of PSS, SSS, PBCH, and PBCH-DMRS. For example, the SSB may include only PSS and SSS, or only PSS, SSS, and PBCH.

In the embodiments described above, for illustration purposes, OFDM is assumed as the waveform for transmission or communication and therefore an OFDM symbol is assumed as a processing unit (e.g., OFDM symbols carrying SSB). However, it should be understood other waveforms may be used such as Single-Carrier (SC), Single-Carrier with Frequency Domain Equalization (SC-FDE), Discrete Fourier Transform spread OFDM (DFT-s-OFDM) and its variants, Single-Carrier with Offset Quadrature Amplitude Modulation (SC-OQAM), Filter Bank Multi-Carrier (FBMC), Generalized Frequency Division Multiplexing (GFDM), Universal Filtered Multi-Carrier (UFMC), or Orthogonal Time Frequency Space (OTFS). As such, while OFDM symbols are used in the embodiments described above, symbols corresponding to the other possible waveforms mentioned above in this paragraph may be applicable in other embodiments.

Some embodiments of the disclosure may enable slot-based data scheduling with timely update of channel estimation after the UE switches reception antennas in slots carrying SSB.

Some embodiments of the disclosure may reduce DCI overhead and UE complexity as compared to mini-slot-based scheduling that requires multiple DCIs to schedule multiple PDSCHs.

While one or more steps of the methods described above are based on dual-polarized antennas with vertical or horizontal polarization directions, or both, it should be understood that the methods may be performed using dual-polarized antennas with ±45 degree slant polarization directions. Similarly, while one or more steps of the methods described above are based on dual-polarized antennas with 90 degree phase difference in a polarization plane (i.e. vertical/horizontal polarization directions, ±45 degree slant polarization directions), it should be understood that the methods may be performed using dual-polarized antennas with a non-90 phase difference (e.g. 60 degree) in a polarization plane. Furthermore, while one or more steps of the methods described above are based on dual-polarized antennas with two polarization directions, it should be understood that the methods may be performed using antenna structures or architectures that may be considered such that the network device or the apparatus is equipped with antennas capable of transmitting or receiving over M polarization directions, where M is an integer greater than 2. In this case, the 2-port SSB mentioned in embodiments or examples illustrated above or elsewhere in the present disclosure may be replaced as M-port SSB.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
transmitting a polarization direction indication indicating a polarization direction for user equipment (UE) beam measurement in symbols carrying reference signals for beam measurement, or for UE data communication in symbols carrying reference signals for beam measurement.

2. The method of claim 1, wherein the reference signals for beam measurement are each one of:
a synchronization signal—physical broadcast channel (SS-PBCH) block (SSB);
a channel state information reference signal (CSI-RS);
a tracking reference signal (TRS); or
a positioning reference signal (PRS).

3. The method of claim 1, wherein the polarization direction indication comprises at least one of an index of a reference signal among the reference signals for beam measurement or an antenna port index identifying an antenna port of two antenna ports used for the transmission of the reference signal among the reference signals for beam measurement, where the two antenna ports correspond to first and second polarization directions of antennas at a base station, or correspond to first and second polarization directions relative to a reference plane.

4. A device comprising:
one or more processors, wherein when the one or more processors executes program instructions stored in the device, the device is caused to:
transmit a polarization direction indication indicating a polarization direction for user equipment (UE) beam measurement in symbols carrying reference signals for beam measurement, or for UE data communication in symbols carrying reference signals for beam measurement.

5. The device of claim 4, wherein the reference signals for beam measurement are each one of:
a synchronization signal—physical broadcast channel (SS-PBCH) block (SSB);
a channel state information reference signal (CSI-RS);
a tracking reference signal (TRS); or
a positioning reference signal (PRS).

6. The device of claim 4, wherein the polarization direction indication comprises at least one of an index of a reference signal among the reference signals for beam measurement or an antenna port index identifying an antenna port of two antenna ports used for the transmission of the reference signal among the reference signals for beam measurement, where the two antenna ports correspond to first and second polarization directions of antennas at a base station, or correspond to first and second polarization directions relative to a reference plane.

7. A method comprising:
receiving a polarization direction indication indicating a polarization direction for user equipment (UE) beam measurement in symbols carrying reference signals for beam measurement, or for UE data communication in symbols carrying reference signals for beam measurement.

8. The method of claim 7, wherein the reference signals for beam measurement are each one of:
a synchronization signal—physical broadcast channel (SS-PBCH) block (SSB);
a channel state information reference signal (CSI-RS);
a tracking reference signal (TRS); or
a positioning reference signal (PRS).

9. The method of claim 7, wherein the polarization direction indication comprises at least one of an index for a reference signal among the reference signals for beam measurement or an antenna port index identifying an antenna port of two antenna ports used for the transmission of the reference signal among the reference signals for beam measurement, where the two antenna ports correspond to first and second polarization directions of antennas at a base station or correspond to first and second polarization directions relative to a reference plane.

10. The method of claim 7 further comprising:
receiving an indication to configure the UE to an alternate polarization direction used for receiving UE data among first and second polarization directions of antennas at a base station or first and second polarization directions relative to a reference plane, over even and odd-indexed periods for reference signals for beam measurement.

11. The method of claim 7 further comprising:
receiving an indication to configure the UE to an alternate polarization direction used for UE beam measurement among first and second polarization directions of antennas at a base station or first and second polarization directions relative to a reference plane, over even and odd-indexed periods for reference signals for beam measurement.

12. The method of claim 7 further comprising:
receiving UE data in symbols carrying a first reference signal for beam measurement, wherein the UE data is in quasi-co-location (QCL) with a second reference signal for beam measurement.

13. The method of claim 7, wherein a maximum number of layers for physical downlink shared channel (PDSCH) reception in symbols carrying reference signals for beam measurement is equal to one.

14. A device comprising:
one or more processors, wherein when the one or more processors execute program instructions stored in the device, the device is caused to:
receive a polarization direction indication indicating a polarization direction for user equipment (UE) beam measurement in symbols carrying reference signals for beam measurement, or for UE data communication in symbols carrying reference signals for beam measurement.

15. The device of claim 14, wherein the reference signals for beam measurement are each one of:
a synchronization signal—physical broadcast channel (SS-PBCH) block (SSB);
a channel state information reference signal (CSI-RS);
a tracking reference signal (TRS); or
a positioning reference signal (PRS).

16. The device of claim 14, wherein the polarization direction indication comprises at least one of an index for a reference signal among the reference signals for beam measurement or an antenna port index identifying an antenna port of two antenna ports used for the transmission of the reference signal among the reference signals for beam measurement, where the two antenna ports correspond to first and second polarization directions of antennas at a base station or correspond to first and second polarization directions relative to a reference plane.

17. The device of claim 14, wherein when the one or more processors execute the program instructions stored in the device, the device is further caused to:
receive an indication to configure the UE to an alternate polarization direction used for receiving UE data among first and second polarization directions of antennas at a base station or first and second polarization directions relative to a reference plane, over even and odd-indexed periods for reference signals for beam measurement.

18. The device of claim 14, wherein when the one or more processors execute the program instructions stored in the device, the device is further caused to:
receive an indication to configure the UE to an alternate polarization direction used for UE beam measurement among first and second polarization directions of antennas at a base station or first and second polarization directions relative to a reference plane, over even and odd-indexed periods for reference signals for beam measurement.

19. The device of claim 14, wherein when the one or more processors execute the program instructions stored in the device, the device is further caused to:
receive UE data in symbols carrying a first reference signal for beam measurement, wherein the UE data is in quasi-co-location (QCL) with a second reference signal for beam measurement.

20. The device of claim 14, wherein a maximum number of layers for physical downlink shared channel (PDSCH) reception in symbols carrying reference signals for beam measurement equal to one.
